(19) United States
(12) Patent Application Publication
(10) Pub. No.: US 2010/0150979 A1
(43) Pub. Date: Jun. 17, 2010

(54) ANTIMICROBIAL WIRING DEVICES

(75) Inventors: Darron Kirby Lacey, Peachtree City, GA (US); Robert Clay Armbruster, Phoenix, AZ (US)

Correspondence Address: KING & SPALDING, LLP, 1100 LOUISIANA ST., STE. 4000, ATTN.: IP Docketing, HOUSTON, TX, 77002-5213, US

(73) Assignee: COOPER TECHNOLOGIES COMPANY, Houston, TX (US)

(21) Appl. No.: 12/335,897

(22) Filed: Dec. 16, 2008

(51) Int. Cl. A01N 31/12; A01N 25/34; A01P 1/00; B29C 71/02; A01N 61/00

(52) U.S. Cl. 424/411; 514/2; 514/736; 264/237

(57) ABSTRACT

Wiring devices that are manufactured by incorporating antimicrobial agents therein help eliminate or reduce any microorganisms that are present on the surface of the wiring device, and thus help prevent the spread of infection and disease from one person to another. By incorporating the antimicrobial agent into a resin mixture used for making wiring devices, the antimicrobial agent continues to leach out to the surface of the wiring device over time, resulting in a more effective, longer-lasting option than conventional cleaners. Methods of fabricating the wiring devices to include antimicrobial agents includes adding a prescribed amount of antimicrobial agent to a base material, mixing the agent and material to create a mixture, and extruding the mixture into one or more molds to form a wiring device of desired configuration.

### TECHNICAL FIELD

The present invention relates generally to the field of wiring devices. More specifically, the present invention relates to wallplates, switches, and other wiring devices that include antimicrobial protection capabilities.

### BACKGROUND

Wiring devices are commonly present in industrial, commercial, and residential areas. As used herein, the term “wiring device” refers to faceplates, wallplates, coverplates, telephone plates, touch pads, dimmer slides, switches, circuit units, plugs, connectors, receptacles, and other similar devices, and may be current-carrying or noncurrent-carrying.

Wiring devices are generally touched by a number of people during normal daily traffic. As a result, the wiring devices are exposed to a number of microorganisms, such as bacteria and fungi, that may be carried by each person. In addition, some microorganisms can be airbourne and deposited onto the wiring devices. These microorganisms can be transferred from one user to another and result in the contraction of an infection or disease. For instance, a nurse tending to a patient in a hospital room contacts a light switch in the room prior to washing his/her hands, thus exposing the light switch to one or more microorganisms. When the next person enters the room and they contact the light switch, they will be exposed to the microorganisms present on the switch. As a result of the exposure, the person's contact could result in an infection.

Currently, wiring devices can be coated with a spray, such as a household cleaner, containing antimicrobial properties. As used herein, the term “antimicrobial agent” refers to any substance that kills or inhibits the growth of microorganisms such as bacteria, fungi, or viruses. The drawback to using sprays having antimicrobial properties is that they wear off over time and thus lose efficacy.

Therefore, a need exists in the art for wiring devices that also have the ability to reliably kill and/or inhibit the growth of microorganisms and prevent the spread of disease caused by transfer at the wiring devices over a long period of time.

### SUMMARY

The wiring devices described herein can aid in eliminating microorganisms present, thus minimizing the possibility of a user contracting an infection. In one aspect of the invention, the wiring devices of the present invention include an antimicrobial agent. The wiring devices also include metal, plastic, or ceramic. The antimicrobial agent is present in the wiring device at a concentration in the range from about 0.5% to about 5% by weight. In certain aspects, the antimicrobial agent is present at a concentration of about 2% by weight. The antimicrobial agent can be natural or synthetic, and my be deionized in certain aspects. Examples of suitable antimicrobial agents include silver-based biocides, copper-based biocides, synthetic antimicrobial peptides, triclosan, silane-based antimicrobial additives, and other suitable biocides.

In another aspect of the invention, methods of the present invention include fabricating the wiring devices of the present invention by an extrusion process. These and other aspects, objects, and features of the invention will become apparent to those, having ordinary skill in the art upon consideration of the following detailed description of exemplary embodiments exemplifying the best mode for carrying out the invention as presently perceived.

### BRIEF DESCRIPTION OF THE DRAWINGS

For a more complete understanding of the exemplary embodiments of the present invention and the advantages thereof, reference is now made to the following description in conjunction with the accompanying drawings in which:

FIG. 1 is a front view of a double switch wallplate according to an exemplary

embodiment of the present invention; and

FIG. 2 is a front view of a power switch according to an exemplary embodiment of the present invention.

### DETAILED DESCRIPTION

The present invention supports an apparatus and method for manufacturing wiring devices that include antimicrobial agents incorporated therein.

Generally, the amount of antimicrobial agent that is included into a mixture for manufacturing the wiring devices is sufficient to provide the desired efficacy for reliably killing and/or inhibiting the growth of microorganisms. In certain embodiments, the amount of antimicrobial agent added to the mixture ranges from about 0.05% to about 10% by weight of the mixture. In one exemplary embodiment, the amount of antimicrobial agent added to the mixture is about 2% by weight of the mixture. The concentration of the antimicrobial agent in the wiring device can vary so long as the end product kills and/or inhibits the growth of microorganisms and the structural integrity of the wiring device is not compromised. The concentration of the antimicrobial agent in the wiring device is also dependent on a variety of factors, such as the desired efficacy and/or reliability, the particular application, the type of antimicrobial agent used, and the like, which will be recognizable by a person skilled in the art.

The antimicrobial agents incorporated into the wiring devices of the present invention can be natural or synthetic, so long as the antimicrobial agents have no toxic effect on the people come into contact with the wiring devices. Suitable examples of antimicrobial agents include, but are not limited to, silver-based antimicrobial agents, copper-based antimicrobial agents, synthetic antimicrobial peptides, triclosan, silane-based antimicrobial additives, and other suitable biocides. Other suitable antimicrobial agents for use in the wiring devices of the present invention include phenolic or chlorinated phenolic compounds, resorcinol or derivatives thereof, bisphenolic compounds, benzoic esters, halogenated carbanilides, polymeric antimicrobial agents, thazolines, trichloromethylthioimide, natural antimicrobial agents, metal salts, broad-spectrum antibiotics, ansamycin derivatives, and ingredients having any antimicrobially active group, e.g. lipophilic members of the aminoglycosides group, of the cephalosporins group and beta-lactams based thereon, of chloramphenicol, lincosamides, macrolides, penicillins, quinolones, sulphonamides, and tetracyclins. In certain exemplary embodiments, the antimicrobial agents having a metallic base are deionized.

The antimicrobial agents in the wiring devices of the present invention can prevent respiration of microorganisms by inhibiting transport functions in the cell wall, inhibit cell division or reproduction, and/or disrupt cell metabolism. The integration of the antimicrobial agents into the wiring devices allows the antimicrobial agents to continuously leach out. As a result, the wiring devices of the present invention can continuously kill microorganisms present on a wiring device and thus prevent the spread of disease while maintaining optimal performance for years.

The wiring devices of the present invention can be prepared by any method suitable for a given application of the wiring device. For example, the non-metallic components used to construct the wiring devices are injection molded from compounds and additives suitable to meet certain requirements, such as mechanical strength, dielectric strength, thermal resistance to heat and cold, and impact. The molding process involves a mold of the desired component and an injection molding machine. The molding compound is placed in an electrically heated plasticizing barrel and heated to a temperature sufficient to create a melt. This melt is then forced or injected into the mold to create a plastic component which is used as a part of the final device assembly. In certain alternative exemplary embodiments, a metal wiring device is manufactured and then a liquid mixture including an antimicrobial agent is applied to a finished metal wiring device. Those having ordinary skill in the art, with the benefit of this disclosure, will be able to determine other suitable methods for the preparation of the wiring devices of the present invention.

Exemplary embodiments of the invention are more readily understood by reference to the accompanying figures and description presented below. Referring now to the drawings in which like numerals represent like elements throughout the figures, aspects of the present invention will be described.

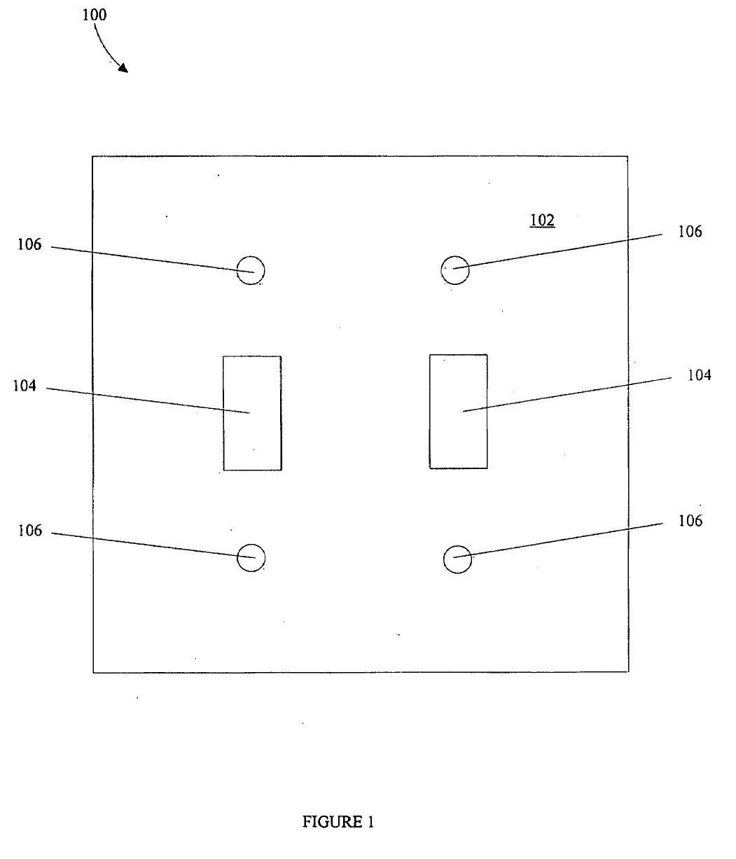

FIG. 1 presents a frontal view of an exemplary wiring device 100 according to one exemplary embodiment of the present invention. Referring to FIG. 1, the exemplary wiring device 100 includes a double switch wallplate 102. The wallplate 102 includes two horizontally aligned openings 104 each having a substantially rectangular shape and configured to receive a toggle style switch or a blank insert (not shown). The wallplate 102 also includes four apertures 106 each positioned above and below the openings 104. The apertures 106 are configured to receive a fastener, such as a screw or other known fastening device (not shown), to couple the wiring device 100 to a wall (not shown).

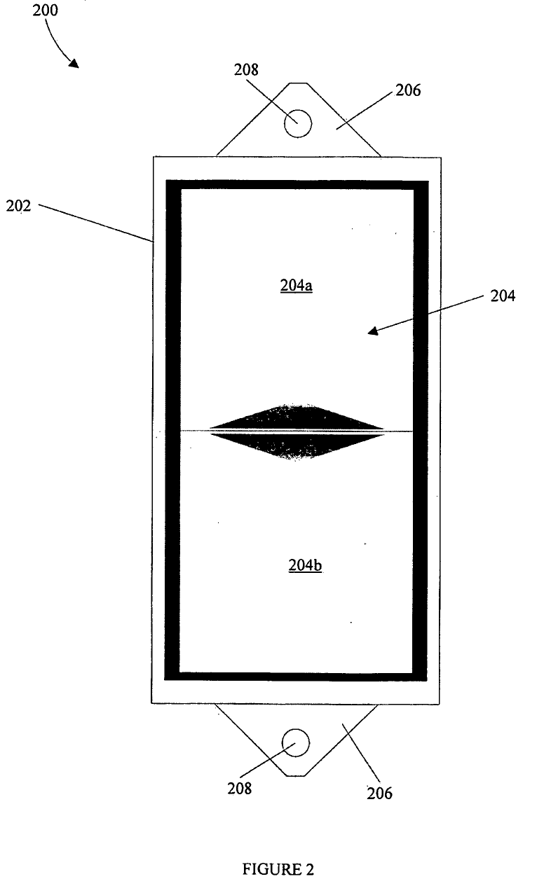

FIG. 2 presents a frontal view of another exemplary wiring device 200 according to one exemplary embodiment of the present invention. Now referring to FIG. 2, the exemplary wiring device 200 is a power switch 202. The power switch 202 includes switch contacts and wiring (not shown) for controlling a remote power device (not shown), such as a light fixture. The power switch 202 also includes a switch face 204 coupled to the switch contacts and wiring in the power switch 202. The switch face 204 further includes a first portion 204a and a second portion 204b, collectively referred to as a paddle, wherein one of the two portions of the paddle is in a depressed state at all times. When the first portion 204a of the paddle is depressed, the switch contacts are connected to complete an electrical circuit and allows power to flow to downstream devices, thereby turning them on. When the second portion 204b of the paddle is depressed, the switch contacts are not in contact and power does not flow to downstream devices, thereby turning them off.

In certain exemplary embodiments, the wiring device 200 also includes two mounting extensions 206 extending from opposite sides of the power switch 202. Each extension 206 includes an aperture 208 through which a fastener, such as a screw or other known fastening device (not shown), is received to couple the wiring device 200 to a wall (not shown).

In one exemplary embodiment, the wiring devices of the present invention, such as the wallplate 102 and the power switch 202, are manufactured by extrusion of a resin mix into a desired configuration. The resin mix includes a polymer, such as polyethylene, polyurethane, thermoplastic elastomers, or other resins, and an antimicrobial agent. In certain alternative embodiments, the wiring devices of the present invention are manufactured by extrusion from a mixture that includes metal, such as aluminum, brass, copper, or the like, and an antimicrobial agent. In certain other embodiments, the wiring devices are constructed from a mixture that includes ceramics and an antimicrobial agent. One having ordinary skill in the art will recognize appropriate materials of construction for fabricating the wiring devices of the present invention.

Therefore, the present invention is well adapted to attain the ends and advantages mentioned as well as those that are inherent therein. The particular embodiments disclosed above are illustrative only, as the present invention may be modified and practiced in different but equivalent manners apparent to those having ordinary skill in the art having the benefit of the teachings herein. While numerous changes may be made by those having ordinary skill in the art, such changes are encompassed within the spirit and scope of this invention as defined by the appended claims. Furthermore, no limitations are intended to the details of construction or design herein shown, other than as described in the claims below. It is therefore evident that the particular illustrative embodiments disclosed above may be altered or modified and all such variations are considered within the scope and spirit of the present invention as defined by the claims below. The terms in the claims have their plain, ordinary meaning unless otherwise explicitly and clearly defined by the patentee.

What is claimed is:

1. A system comprising:
a wiring device comprising
a base material; and
an antimicrobial agent.

2. The system of claim 1, wherein the wiring device is selected from the group consisting of faceplates, wallplates, coverplates, telephone plates, touch pads, dimmer slides, switches, receptacles, circuit units, plugs, connectors, and receptacles.

3. The system of claim 1, wherein the base material comprises at least one selected from the group consisting of polymers, metals, and ceramics.

4. The system of claim 1, wherein the antimicrobial agent is selected from the group consisting of silver-based antimicrobial agents, copper-based antimicrobial agents, synthetic antimicrobial peptides; triclosan, and silane-based antimicrobial additives.

5. The system of claim 1, wherein the antimicrobial agent is a metal-based antimicrobial agent and wherein the metal is deionized.

6. The system of claim 1, wherein the antimicrobial agent comprises about 0.5% to about 5% by weight of the mixture.

7. The system of claim 1, wherein the antimicrobial agent comprises about 2% by weight of the mixture.

8. A method of manufacturing a wiring device comprising the steps of:
providing a base material;
providing an antimicrobial agent;
mixing the base material and the antimicrobial agent into a mixture; and
distributing the mixture into a plurality of molds for a wiring device.

9. The method of claim 8, further comprising the steps of:
heating the mixture;
extruding the mixture into the plurality of molds for a wiring device; and
cooling the extruded mixture in the plurality of molds for a wiring device.

10. The method of claim 8, wherein the wiring device is selected from the group consisting of faceplates, wallplates, coverplates, telephone plates, touch pads, dimmer slides, switches, receptacles, circuit units, plugs, connectors, and receptacles.

11. The method of claim 8, wherein the base material comprises at least one selected from the group consisting of polymers, metals, and ceramics.

12. The method of claim 8, wherein the antimicrobial agent is selected from the group consisting of silver-based antimicrobial agents, copper-based antimicrobial agents, synthetic antimicrobial peptides, triclosan, and silane-based antimicrobial additives.

13. The method of claim 8, wherein the antimicrobial agent is a metal-based antimicrobial agent and wherein the metal is deionized.

14. The method of claim 8, wherein the antimicrobial agent comprises about 0.5% to about 5% by weight of the mixture.

15. The method of claim 8, wherein the antimicrobial agent comprises about 2% by weight of the mixture.
